(19) United States
(12) Patent Application Publication
(10) Pub. No.: US 2011/0194794 A1
(43) Pub. Date: Aug. 11, 2011

(54) NOISE ISOLATING ROLLING ELEMENT BEARING FOR A CRANKSHAFT

(75) Inventor: Mark A. Joki, Dover, OH (US)

(73) Assignee: KOYO BEARINGS USA LLC, Westlake, OH (US)

(21) Appl. No.: 12/920,552

(22) PCT Filed: Oct. 22, 2009
(86) PCT No.: PCT/US2009/061665

§ 371 Date: Sep. 1, 2010

Related U.S. Application Data
(60) Provisional application No. 61/108,592, filed on Oct. 27, 2008.

(51) Int. Cl. F16C 9/02; F16C 19/24; F16C 33/58

(52) U.S. Cl. 384/457; 384/548; 384/462; 384/475

(57) ABSTRACT

A radial rolling element bearing (10) for supporting a shaft (14) for rotation with respect to an adjacent support surface (38). The radial rolling element bearing (14) includes a plurality of rolling elements (18) and a race (22). The race includes a convex first surface (44) that forms a raceway for the plurality of rolling elements and a second surface (48) opposite the convex first surface having a profile that forms a hollow space (52) between the second surface of the race and one of the adjacent support surface and the shaft. The hollow space has a first volume when a first radial load is applied to the bearing, and the hollow space has a second volume less than the first volume when a second radial load greater than the first radial load is applied to the bearing.

### CROSS-REFERENCE TO RELATED APPLICATIONS

This application claims priority to U.S. Provisional Patent Application No. 61/108,592, filed Oct. 27, 2008, the entire contents of which are incorporated by reference herein.

### BACKGROUND

The present invention relates to bearings, and more particularly to bearings for crankshafts of combustion engines.

The type of bearing most commonly used in automotive and other internal combustion engines is called a hydrodynamic plain bearing. Hydrodynamic plain bearings depend on a fluid film supplied by a continuous flow of externally pressurized lubricant to support a load and separate moving parts. Hydrodynamic plain bearings operate by using the relative motion of a shaft to further increase the fluid pressure of the fluid film and to generate a localized wedge of compressed lubricant to support the load.

Another type of bearing that may be used is a rolling element bearing. Rolling element bearings require minimal amounts of lubricant and are capable of operating without external pressurized sources. As the bearing elements roll forward they collect and compress any lubricant fluid that is deposited on the bearing surfaces. The minute fluid wedges that are generated by this motion have very high pressures that support the concentrated loads.

### SUMMARY

Utilizing rolling element bearings for the crankshaft of combustion engines can provide advantages over hydrodynamic plain bearings, such as efficiency. However, rolling element bearings can produce substantial noise. The rolling element bearing embodying the present invention reduces the transmission of noise into the crankcase.

Hydrodynamic plain bearings require a continuous flow of externally pressurized lubricant and will fail quickly if this is not provided. There are significant frictional losses associated with the operation of hydrodynamic bearings due primarily to the shearing that occurs within the fluid films. As much as one quarter of the total engine friction is attributable to this source of friction and heat.

Rolling element bearings do not suffer from the same frictional losses as hydrodynamic plain bearings. The fluid wedges that are formed between the rolling elements and the bearing surface are minute and produce little shearing and therefore much lower friction levels. Rolling element bearings, or anti-friction bearings, operate with little lubricant which also makes them very tolerant of variable lubrication conditions and interruptions. However they are rarely used in engine applications due to the relatively large amount of noise and vibration they transmit.

There is considerable interest in improving the efficiency of automotive and other internal combustion engines for better fuel economy and lower emissions. One way to accomplish this is to replace hydrodynamic engine bearings with rolling element designs. This is technically feasible, but there is a problem with noise and vibration. Hydrodynamic fluid film bearings generate very little noise or vibration themselves and may actually absorb noise or vibration caused by other sources such as crankshaft harmonics. Rolling element bearings, in contrast, generate periodic vibrations as a natural function of their operation. These vibrations are transmitted to their surroundings and can excite resonances which can be felt or heard with undesirable consequences. The present invention allows the use of more efficient rolling element bearings without the negative effects of noise and vibration transmission to the engine structure.

In one embodiment, the invention provides a radial rolling element bearing for supporting a shaft for rotation with respect to an adjacent support surface. The radial rolling element bearing includes a plurality of rolling elements and a race. The race includes a convex first surface that forms a raceway for the plurality of rolling elements and a second surface opposite the convex first surface having a profile that forms a hollow space between the second surface of the race and one of the adjacent support surface and the shaft. The hollow space has a first volume when a first radial load is applied to the bearing, and the hollow space has a second volume less than the first volume when a second radial load greater than the first radial load is applied to the bearing.

In another embodiment, the invention provides a crankshaft bearing assembly including a support surface and a crankshaft rotatable with respect to the support surface to generate a first radial load and a second radial load greater than the first radial load. The assembly further includes a radial rolling element bearing for supporting the crankshaft for rotation with respect to the support surface. The radial rolling element bearing includes a plurality of rolling elements, and a race including a convex first surface that forms a raceway for the plurality of rolling elements, and a second surface opposite the convex first surface having a profile that forms a hollow space between the second surface of the race and one of the support surface and the crankshaft. The hollow space has a first volume when the first radial load is applied to the bearing and the hollow space has a second volume less than the first volume when the second radial load is applied to the bearing.

Other aspects of the invention will become apparent by consideration of the detailed description and accompanying drawings.

### BRIEF DESCRIPTION OF THE DRAWINGS

FIG. 1 is a partial cross-section view of a crankshaft bearing assembly embodying the present invention.

FIG. 2 is a graph illustrating the deflection of a bearing of the assembly versus radial load applied to the bearing for one construction of the crankshaft bearing assembly of FIG. 1.

FIG. 3 is a partial cross-section view of an alternative embodiment of the crankshaft bearing assembly of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

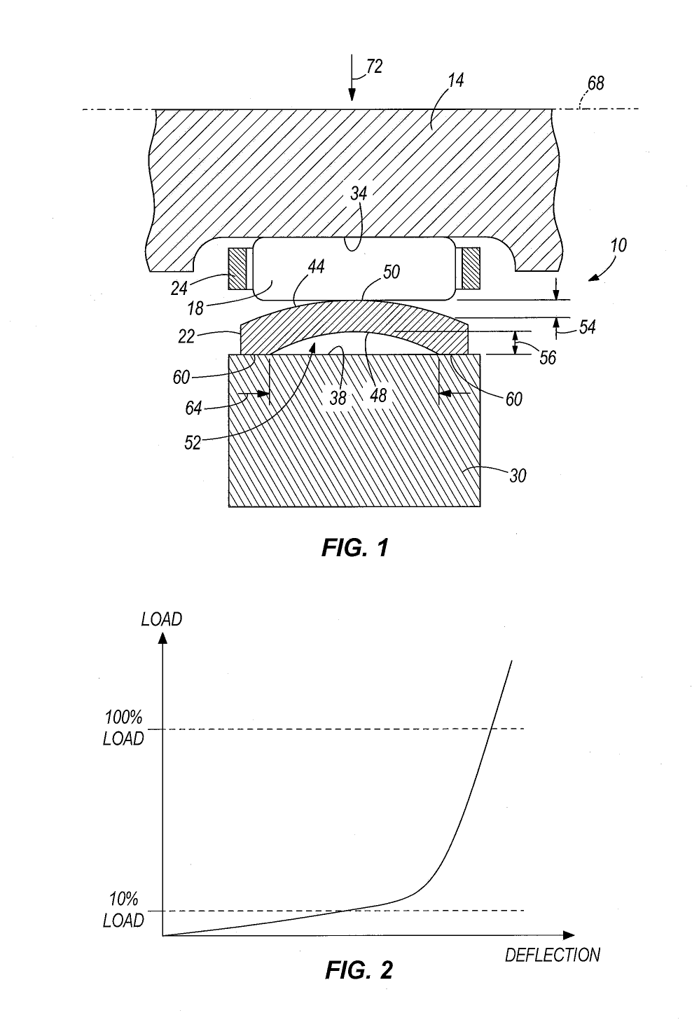

FIG. 1 illustrates an embodiment of a bearing 10 that supports a shaft 14. The bearing 10 includes a plurality of rolling elements 18, a race 22, and a retainer or cage 24. The illustrated shaft 14 is a crankshaft for an internal combustion engine and the bearing 10 supports the crankshaft 14 for rotation with respect to a crankcase 30. The illustrated crankshaft 14 includes a cylindrical journal portion 34 for retaining the bearing 10 in proper alignment with the crankcase 30. A cylindrical bore of the crankcase 30 includes a bearing support surface 38. In other embodiments, the shaft 14 could be a camshaft, a balance shaft, or another type of shaft, either in an internal combustion engine or in other non-engine applications.

The plurality of rolling elements 18 support the shaft 14 such that the shaft 14 can rotate and transmit force. The rolling elements 18 roll or run directly on the cylindrical journal portion 34 of the shaft 14 in the illustrated construction. In other constructions, an inner race can be disposed between the journal portion 34 and the rolling elements 18 such that the rolling elements roll along the inner race.

The plurality of rolling elements 18 are cylindrical rolling elements that are often referred to as needles or pins, but could be other types of rolling elements including balls, tapered rolling elements, or other known types of rolling elements. In addition, the cage 24 may be removed and the plurality of rolling elements 18 may be a full or partial complement of rolling elements 18. Furthermore, the illustrated cage 24 is a split cage to allow for installation around the cylindrical journal 34.

The race 22 includes a convex inner surface or crown surface 44, and a concave outer surface 48 opposite the inner surface 44. The crown surface 44 forms a raceway 50 for the rolling elements 18 to roll along. As seen in FIG. 1, the concave outer surface 48 has a profile that defines a volume or hollow space 52 bound by the concave surface 48 and the support surface 38. In one construction, the crown surface 44 has a height 54 of 400 μinches and the hollow space 52 has a depth 56 of 300 μinches. Of course, in other constructions, the height 54 of the crown surface 44 and the depth 56 of the hollow space 52 can be any suitable dimension. The race 22 further includes generally cylindrical flat lands or support surfaces 60 at both ends of the concave outer surface 48 of the race 22. The surfaces 60 support the race 22 on the support surface 38 of the crankcase 30. A length 64 of the concave outer surface 48 is defined as the distance between lands 60 as illustrated in FIG. 1. In one construction, an intermediate sleeve may be used between the race 22 and the support surface 38 of the crankcase 30 to reduce fretting or wear at the lands 60.

In the illustrated construction, the race 22 is an outer race of the bearing (i.e., located radially outward from the center of rotation of the shaft 14 compared to the journal portion 34 or inner raceway. In other constructions, the race 22 can be the inner race and adjacent the shaft 14. In addition, in the illustrated construction, the race 22 is a split race to facilitate installation around the cylindrical journal portion 34 of the shaft 14.

During operation, the crankshaft 14 rotates about axis 68 and variable radial loads (represented by arrow 72 in FIG. 1) are applied to the bearing 10. Accordingly, the bearing 10 is a radial bearing compared to a thrust bearing that supports axial loads (i.e., along axis 68). Under relatively light radial loads, the race 22 easily deforms. As radial loads are applied to the bearing 10, the lands 60 slide or spread apart along the support surface 38. Therefore, the length 64 of the hollow space 52 increases while the depth 56 of the hollow space 52 also decreases and the volume of the space 52 decreases.

The race 22 has a relatively low spring rate because of the hollow space 52, and the low spring rate generates low vibration forces as the rolling elements 18 encounter non-uniformities in the contact surfaces (i.e., raceway 50 or the journal portion 34). FIG. 2 graphically illustrates this low spring rate. In one construction, the race 22 is formed from bearing steel. In other constructions, the race 22 can be formed from any suitable material, including other types of steel and the like.

Under a relatively heavy or large radial load, the race 22 deforms such that the hollow space 52 disappears or is eliminated. Thus, the raceway 50 is supported with high stiffness or a higher spring rate than when the hollow space 52 is present. FIG. 2 graphically illustrates this high stiffness (i.e., slope of the line) at 100 percent load. In one construction, the load at which the space 52 disappears is in the range of 30-60 percent of a full or maximum radial load.

The crown surface 44 of the race 22 creates a small contact size or zone with the rolling elements 18 at relatively low radial loads resulting in low hydrodynamic drag. At relatively high radial loads, the height 54 of the crown surface 44 decreases resulting in a larger contact zone and lower contact stresses, and therefore, high durability of the bearing 10.

In one embodiment, a resilient coating may be applied to the race 22 on the outer surface 48 to provide additional vibration dampening. In addition, or in another embodiment, a supply of oil may be provided into the hollow space 52 to provide yet further dampening. In such a construction, an axial groove in the lands 60 can be used to provide the supply of oil to the space 52.

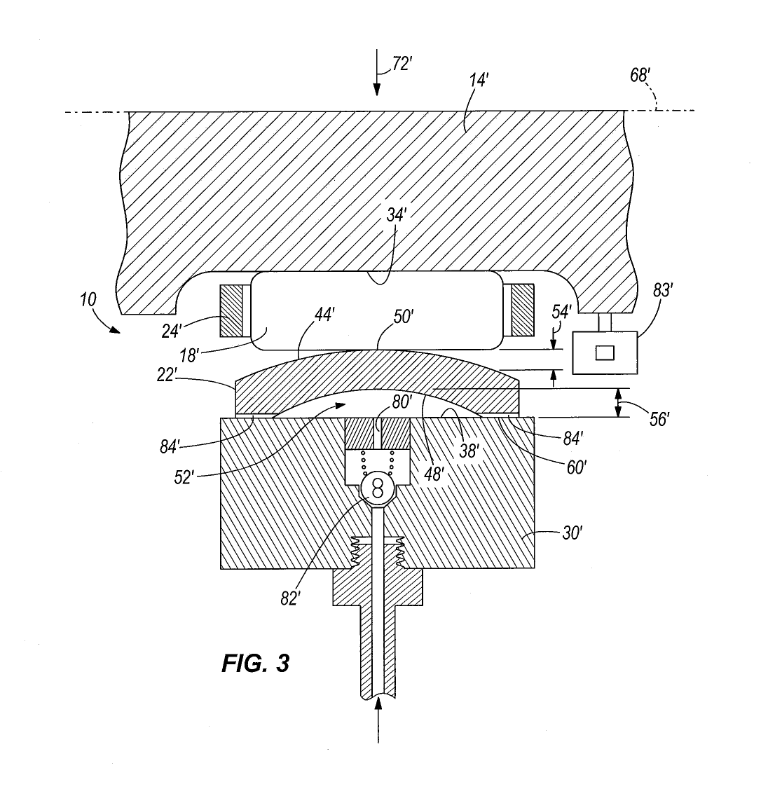

FIG. 3 illustrates an alternative embodiment of the bearing 10 of FIG. 1. The bearing 10′ of FIG. 3 is similar to the bearing 10 of FIG. 1 and like components have been given like reference numbers with the addition of a prime symbol and only differences between the embodiments will be discussed herein.

Referring to FIG. 3, after the split race 22′ is installed into the crankcase 30′, uncured polymer is injected under pressure through an aperture or port 80′ and into the hollow space 52′. This allows a setting of a small preload of the rolling elements 18′ and race 22′ to minimize operating vibration. The polymer can include such polymers as, epoxy resin, urethane, or RTV, and the polymer may include compressible air bubbles or compressible particles. A check valve 82′ retains the polymer within the hollow space 52′. A shaker and accelerometer 83′ are temporarily coupled to the shaft 14′. As the polymer is being injected into the space 52′, the accelerometer 83′ measures the vibration of the shaft 14′ caused by the shaker. When the vibration of the shaft 14′ begins to decrease or reaches a desirable level, the polymer injection stops to provide the desired preload to the race 22′.

The lands 60′ include axially directed shallow scratches or grooves 84′ that allow air pockets to escape the space 52′ during polymer injection but not the polymer because the polymer has a substantially higher viscosity than the air. Any presence of air pockets within the space 52′ can cause the polymer to creep when the bearing 10′ is loaded, thus reducing or relieving the preload of the race 22′.

During operation, radial load is applied to the bearing 10′ from the shaft 14′. Therefore, the race 22′ contracts to reduce the height 54′ of the crown surface 44′ because of the contact between the rolling elements 18′, the journal portion 34′ of the shaft 14′, and the race 22′, and the pressure increases in the polymer within the space 52′. In addition, the polymer may contain small compressible particles or air bubbles that provide a lower stiffness until a sufficiently high load is applied to the bearing 10′. When such a high load is applied to the bearing 10′, the pressure in the polymer causes the particles or bubbles to compress, which increases the stiffness of the bearing race 22′ under the higher load. Accordingly, the air bubbles or compressible particles provide the polymer with two spring rates.

Thus, the invention provides, among other things, a radial rolling element bearing for a crankshaft that reduces noise and vibration.

What is claimed is:

1. A radial rolling element bearing for supporting a shaft for rotation with respect to an adjacent support surface, the radial rolling element bearing comprising:
a plurality of rolling elements; and
a race including,
a convex first surface that forms a raceway for the plurality of rolling elements; and
a second surface opposite the convex first surface having a profile that forms a hollow space between the second surface of the race and one of the adjacent support surface and the shaft,
wherein the hollow space has a first volume when a first radial load is applied to the bearing, and
wherein the hollow space has a second volume less than the first volume when a second radial load greater than the first radial load is applied to the bearing.

2. The radial rolling element bearing of claim 1, wherein the race is an outer race of the bearing such that the hollow space is formed between the second surface and the adjacent support surface.

3. The radial rolling element bearing of claim 2, further comprising a resilient polymer within the hollow space.

4. The radial rolling element bearing of claim 3, further comprising an aperture extending through the adjacent support surface in fluid communication with the hollow space, wherein the polymer is injected into the hollow space through the aperture.

5. The radial rolling element bearing of claim 1, wherein the plurality of rolling elements are cylindrical rolling elements.

6. The radial rolling element bearing of claim 1, wherein when a third radial load greater than the second radial load is applied to the bearing, the second surface of the race contacts one of the adjacent support surface and the shaft such that the hollow space is eliminated.

7. The radial rolling element bearing of claim 6, wherein a full load is defined as a maximum radial load applied to the bearing, and wherein the resiliency of the race is such that the third load is about 30 to 60 percent of the full load.

8. The radial rolling element bearing of claim 1, wherein a portion of the profile of the second surface is concave.

9. The radial rolling element bearing of claim 8, wherein the second surface includes a cylindrical flat support surface that supports the race on the one of the shaft and the adjacent support surface.

10. The radial rolling element bearing of claim 9, wherein the cylindrical flat support surface includes an axial groove that extends across the cylindrical flat support surface to provide fluid communication with the hollow space.

11. The radial rolling element bearing of claim 1, wherein the adjacent support surface is an engine crankcase, and wherein the shaft is an engine crankshaft.

12. The radial rolling element bearing of claim 1, further comprising a resilient coating on at least a portion of the second surface.

13. A crankshaft bearing assembly comprising:
a support surface;
a crankshaft rotatable with respect to the support surface to generate a first radial load and a second radial load greater than the first radial load; and
a radial rolling element bearing for supporting the crankshaft for rotation with respect to the support surface, the radial rolling element bearing including,
a plurality of rolling elements, and
a race including a convex first surface that forms a raceway for the plurality of rolling elements, and a second surface opposite the convex first surface having a profile that forms a hollow space between the second surface of the race and one of the support surface and the crankshaft,
wherein the hollow space has a first volume when the first radial load is applied to the bearing, and
wherein the hollow space has a second volume less than the first volume when the second radial load is applied to the bearing.

14. The crankshaft bearing assembly of claim 13, wherein the race is an outer race of the radial rolling element bearing such that the hollow space is formed between the second surface and the support surface.

15. The crankshaft bearing assembly of claim 13, wherein the support surface includes a crankcase.

16. The crankshaft bearing assembly of claim 13, further comprising a resilient polymer within the hollow space.

17. The crankshaft bearing assembly of claim 16, further comprising an aperture extending through the support surface in fluid communication with the hollow space, wherein the resilient polymer is injected into the hollow space through the aperture.

18. The crankshaft bearing assembly of claim 13, wherein a portion of the profile of the second surface is concave.

19. The crankshaft bearing assembly of claim 13, wherein the second surface includes a cylindrical flat support surface that supports the race on the one of the crankshaft and the support surface.

20. The crankshaft bearing assembly of claim 19, wherein the cylindrical flat support surface includes an axial groove that extends across the cylindrical flat support surface to provide fluid communication with the hollow space.
